(19) United States
(12) Patent Application Publication
(10) Pub. No.: US 2006/0237438 A1
(43) Pub. Date: Oct. 26, 2006

(54) Temperature sensor assembly for an electrical heating arrangement

(76) Inventors: Peter Ravenscroft Wilkins, Worcestershire (GB); Brian Roger Alves, Worcestershire (GB); David Walker, West Midlands (GB)

Correspondence Address: Ira S Dorman, 330 Roberts Street, Suite 200, East Hartford, CT, 06108, US

(21) Appl. No.: 10/559,440

(22) PCT Filed: Jun. 10, 2004
(86) PCT No.: PCT/GB04/02514

§ 371 Date: Apr. 11, 2006

(30) Foreign Application Priority Data
Jun. 13, 2003 (GB) 0313703.1

(51) Int. Cl. H05B 1/02

(52) U.S. Cl. 219/505

(57) ABSTRACT

A temperature sensor assembly (30) is provided for an electrical heating arrangement (2). The temperature sensor assembly (30) comprises: a thin substantially planar substrate (32) having an upper surface (34) provided with a temperature-sensitive electrical resistance element (38) of film form, and a lower surface (64), the temperature-sensitive electrical resistance element (38) being provided with electrical connecting leads (40, 42). A support member (54) has an upper surface (60) adapted to receive the substantially planar substrate (32) with the lower surface (64) of the substrate (32) juxtaposed therewith. Thermal insulation means (62) is interposed between at least the lower surface (64) of the substantially planar substrate (32) and the support member (54) at least at a region where the temperature-sensitive electrical resistance element (38) is provided.

This invention relates to a temperature sensor assembly for use with an electrical heating arrangement in a cooking appliance, in which a cooking plate, such as of glass-ceramic material, has an upper surface for receiving a cooking utensil and a lower surface having supported in contact therewith an electric heater incorporating at least one electric heating element.

It is well known to provide an electrical heating arrangement for a cooking appliance in which a temperature sensing device is arranged under a glass-ceramic cooking plate in order to monitor the temperature of the cooking plate and to operate to de-energise one or more heating elements in a heater under the cooking plate when a particular temperature is reached, in order to prevent thermal damage to the cooking plate.

Requirements exist for sensing the temperature of a cooking utensil, such as a pan, located on the upper surface of a cooking plate, using a temperature sensing device provided underneath the cooking plate. A problem is encountered in that it is required to be able to measure small changes in temperature in the cooking plate overlying the temperature sensing device, such as, for example, occur when a boil-dry situation arises in the cooking utensil. Good thermal coupling is required between the temperature sensing device and the cooking plate. However, the temperature sensing device also receives direct thermal radiation from the one or more heating elements in the underlying heater and this makes it very difficult for the temperature sensing device to distinguish the small changes in temperature of the cooking plate associated with the boil dry situation, or any other situation where small changes in temperature in the cooking plate are required to be monitored. Furthermore, thermal “noise” arising from fluctuations in a controlled set-point temperature in the heater can interfere with the measurement of the small changes in temperature in the cooking plate.

It is known to provide what is referred to as a ‘cool patch’ of a glass-ceramic cooking plate within a heated area by an arrangement in which a discrete temperature sensing device surrounded by a thermally insulating enclosure is urged directly against a region of the lower surface of the cooking plate, to sense a change in temperature of the cooking plate produced by an overlying cooking utensil conducting heat back into the cooking plate in that area. Such a discrete temperature sensing device has been provided of capillary or electromechanical form, or of platinum resistance temperature detector form, urged against the lower surface of the cooking plate, such as by spring loading means. Such an arrangement is bulky and expensive to implement.

It is an object of the present invention to overcome or minimise this problem.

According to one aspect of the present invention there is provided a temperature sensor assembly for an electrical heating arrangement, the temperature sensor assembly comprising: a thin substantially planar substrate having a first surface provided with a temperature-sensitive electrical resistance element of film form, and a second surface, the temperature-sensitive electrical resistance element being provided with electrical connecting leads; a support member having a first surface adapted to receive the substantially planar substrate with the second surface of the substrate juxtaposed therewith; and thermal insulation means interposed between at least the second surface of the substantially planar substrate and the support member at least at a region where the temperature-sensitive electrical resistance element is provided.

The support member may have a recess provided in its upper surface, the recess being adapted and arranged to receive the substantially planar substrate and the thermal insulation means.

The thermal insulation means may additionally be interposed between the support member and one or more side edges of the substantially planar substrate in the recess.

The thermal insulation means may comprise a thin layer of microporous thermal insulation material and/or alternative thermal insulation material. The alternative thermal insulation material may be selected from vermiculite, perlite, mineral fibre, calcium silicate and inorganic foam and mixtures thereof.

The thermal insulation means may be suitably provided with a thickness thereof of from 1 to 10 mm, preferably from 2 to 4 mm, between the substantially planar substrate and the support member.

The support member may comprise a ceramic material, such as steatite, cordierite or alumina. Alternatively, the support member may be made of metal, such as stainless steel.

The substantially planar substrate may be selected from ceramic materials such as a ceramic comprising 85-99 weight percent alumina, glass ceramic and aluminium nitride and a metallic material having a dielectric coating and may have a thickness from about 0.25 mm to about 3 mm, preferably from about 0.5 mm to about 1 mm.

The support member may be of elongate form arranged as a beam and adapted to extend at least partly across a heater of an electrical heating arrangement, the beam being adapted to extend from a peripheral region of the heater. Such support member of elongate form may have a first end thereof adapted to be secured at the peripheral region of the heater and a second end thereof adapted to be within the heater, the temperature-sensitive electrical resistance element being located at or near the second end thereof, with the electrical connecting leads extending from the temperature-sensitive electrical resistance element to the first end of the support member.

The substantially planar substrate may be of elongate form, extending along the elongate support member and having the temperature-sensitive electrical resistance element located at a first end region thereof and with the electrical connecting leads being provided of film form on the substrate and extending to a second end region thereof located at the first end of the support member. The film-form electrical connecting leads may comprise substantially the same or similar material as the temperature-sensitive electrical resistance element.

Electric terminal means for the film-form electrical connecting leads may be provided at the second end region of the substantially planar substrate. Such electric terminal means may comprise electrically conductive pads, such as comprising substantially the same or similar material as the electrical connecting leads or a different material such as gold, to which external connecting leads may be arranged to be connected, such as by soldering, brazing or welding.

Alternatively, holes may be provided through the pads and through the substantially planar substrate, for receiving electrically connecting members, which may have electrically conductive terminal tabs or pins associated therewith for connection to external circuitry. Such holes may also be provided through an underlying region of the support member and arranged to receive the electrically connecting members, whereby the substantially planar substrate is secured to the support member. The electrically connecting members may comprise bolts, pins or rivets. The bolts may suitably comprise brass, plated with gold, silver or nickel. The rivets may suitably comprise brass or copper, plated with gold, silver or nickel.

The thermal insulation means may be provided interposed between the elongate substantially planar substrate and the elongate support member over substantially the full length of the substrate or substantially only at a region thereof where the temperature-sensitive electrical resistance element is provided. When the thermal insulation means is provided substantially only at the region where the temperature-sensitive electrical resistance element is provided, at least one slot means may be provided extending through and partly across the substrate, whereby thermal conduction along the substrate is reduced.

A metal mounting bracket may be provided, having a first portion thereof secured to the first end of the elongate support member, externally of the heater and a second portion thereof adapted to be secured to an external region of a heater of an electrical heating arrangement, such as to an external region at the peripheral wall of the heater.

The first portion of the mounting bracket may be arranged with clip means engaging portions of the first end of the elongate support member, which may be provided as recesses or rebates in the elongate support member. The recesses or rebates may be dimensioned to allow longitudinal adjustment of the elongate support member on the first portion of the mounting bracket.

The mounting bracket may be adapted and arranged to bias the elongate support member towards the lower surface of a cooking plate of an electrical heating arrangement. For this purpose, the mounting bracket may be of cantilevered form, formed from a single sheet or strip of metal and arranged such that, when fitted to the heater, the second end of the elongate support member is biased upwardly towards the lower surface of the cooking plate.

Alternatively, the mounting bracket may have the first and second portions formed separately, to provide upper and lower components respectively, and assembled together such that limited relative displacement in a substantially vertical plane is permitted therebetween, spring means, such as of coil spring or leaf spring form, being provided intermediate the relatively-displaceable first and second portions and acting to urge the elongate support member towards the lower surface of the cooking plate.

The mounting bracket may comprise stainless steel, plated mild steel, or a high temperature resistant plastics material.

A temperature-responsive means may additionally be provided having a rod-like or beam-like portion adapted to extend at least partly across the heater from a peripheral region of the heater and adapted to monitor temperature in a cavity formed between the at least one electric heating element and the lower surface of the cooking plate. The temperature-responsive means may be arranged to cooperate with external control circuitry for de-energising the at least one electric heating element at a predetermined temperature and/or for controlling the temperature in the cavity within selected predetermined limits.

The temperature-responsive means may be arranged with the rod-like or beam-like portion thereof extending at least partly across the heater at a location substantially underlying the elongate support member of the temperature sensor assembly and may share the mounting bracket provided for the elongate support member of the temperature sensor assembly.

The support member may have a second surface thereof provided with a layer of thermal radiation-reflecting material.

An electrically insulating or passivation layer may be provided on the first surface of the substantially planar ceramic substrate at least overlying the temperature-sensitive electrical resistance element.

The temperature-sensitive electrical resistance element may comprise platinum.

According to another aspect of the present invention there is provided an electrical heating arrangement comprising: a cooking plate having an upper surface for receiving a cooking utensil, and a lower surface; an electric heater incorporating at least one electric heating element, the heater being supported in contact with the lower surface of the cooking plate; and a temperature sensor assembly as hereinbefore defined, the temperature sensor assembly being located in the electrical heating arrangement spaced above the at least one electric heating element in contact with the lower surface of the cooking plate and with the temperature-sensitive electrical resistance element facing the lower surface of the cooking plate.

The cooking plate may comprise glass-ceramic material.

The elongate support member may traverse an aperture or recess provided in a peripheral wall of the electric heater such that the first end of the elongate support member is located externally of the heater. The elongate support member may be provided with a transverse recess extending across a lower surface thereof in a location where the elongate support member traverses the aperture or recess in the peripheral wall of the heater, whereby the size of the aperture or recess in the peripheral wall is able to be minimised. The peripheral wall may comprise or include thermal insulation material.

The substantially planar substrate may also traverse, on the elongate support member, the aperture or recess provided in the peripheral wall of the electric heater, such that the second end region of the substrate is located externally of the heater.

The at least one electric heating element may comprise a radiant electrical resistance heating element or an electrical induction heating element.

By means of the present invention, a temperature sensor assembly is provided, incorporating thermal insulation means and which is compact, robust, sensitive and efficient in operation.

For a better understanding of the present invention and to show more clearly how it may be carried into effect, reference will now be made, by way of example, to the accompanying drawings in which:

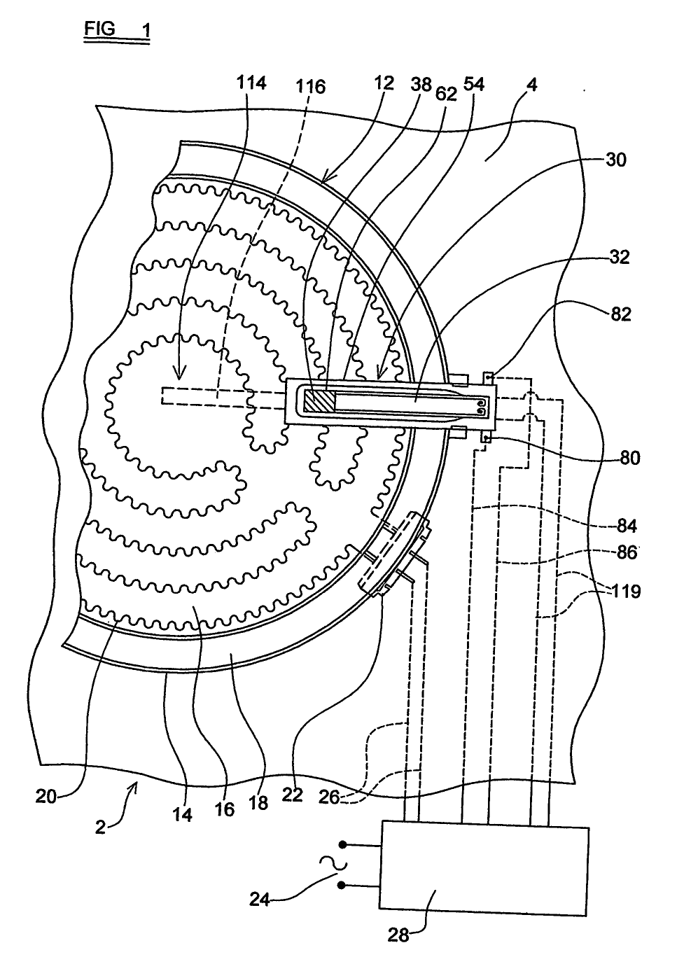

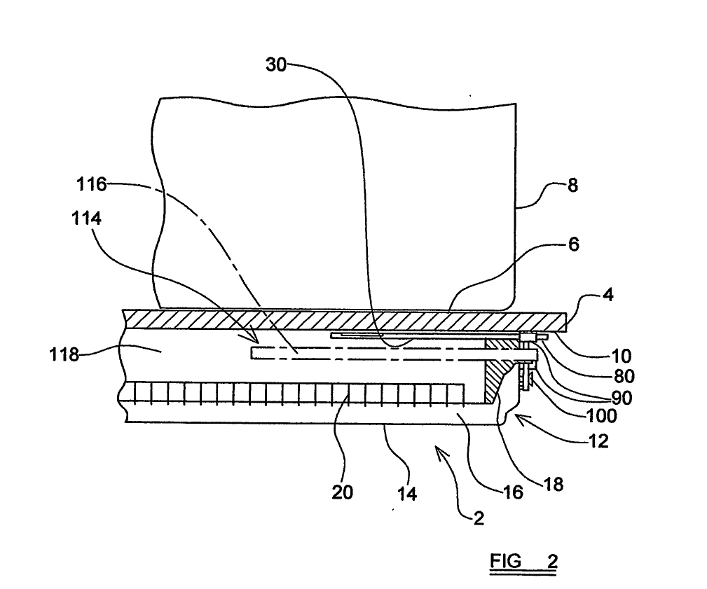

FIG. 1 is a plan view of an electrical heating arrangement provided with a temperature sensor assembly according to the present invention;

FIG. 2 is a cross-sectional view of the arrangement of FIG. 1;

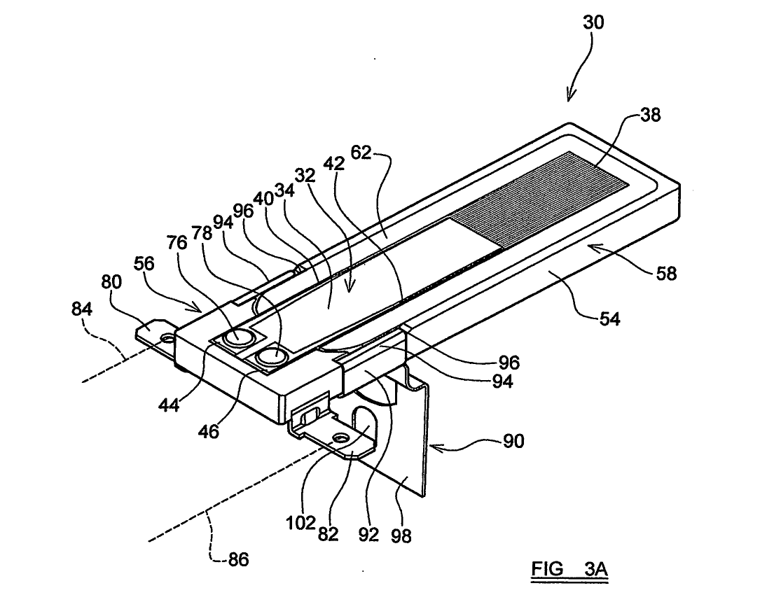

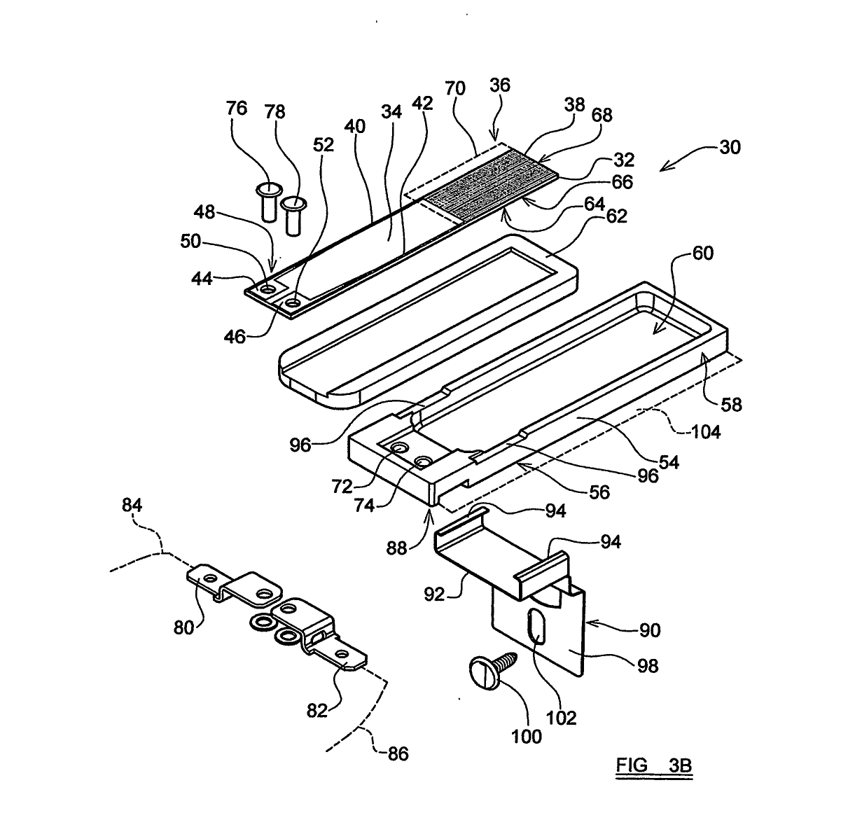

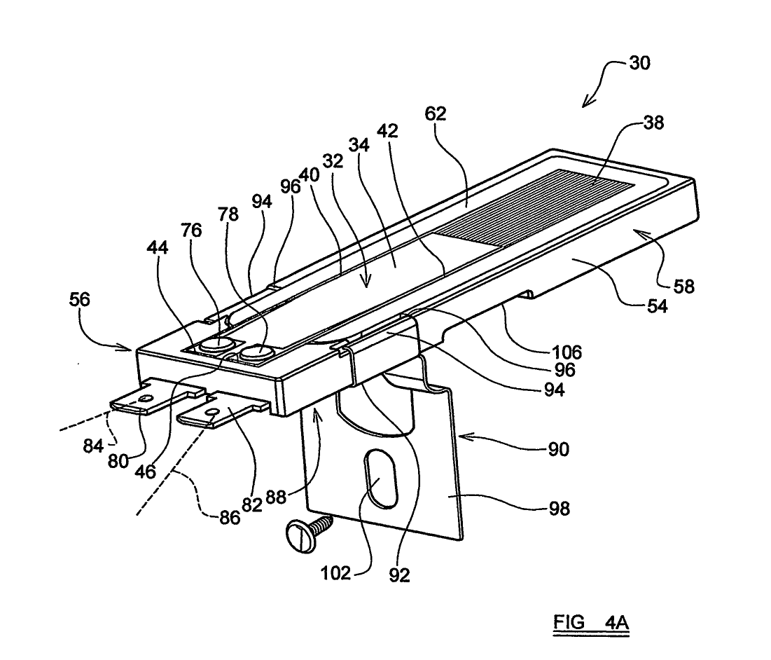

FIG. 3A is a perspective view of an embodiment of temperature sensor assembly of the present invention for use in the arrangement of FIGS. 1 and 2;

FIG. 3B is an exploded view of the temperature sensor assembly of FIG. 3A;

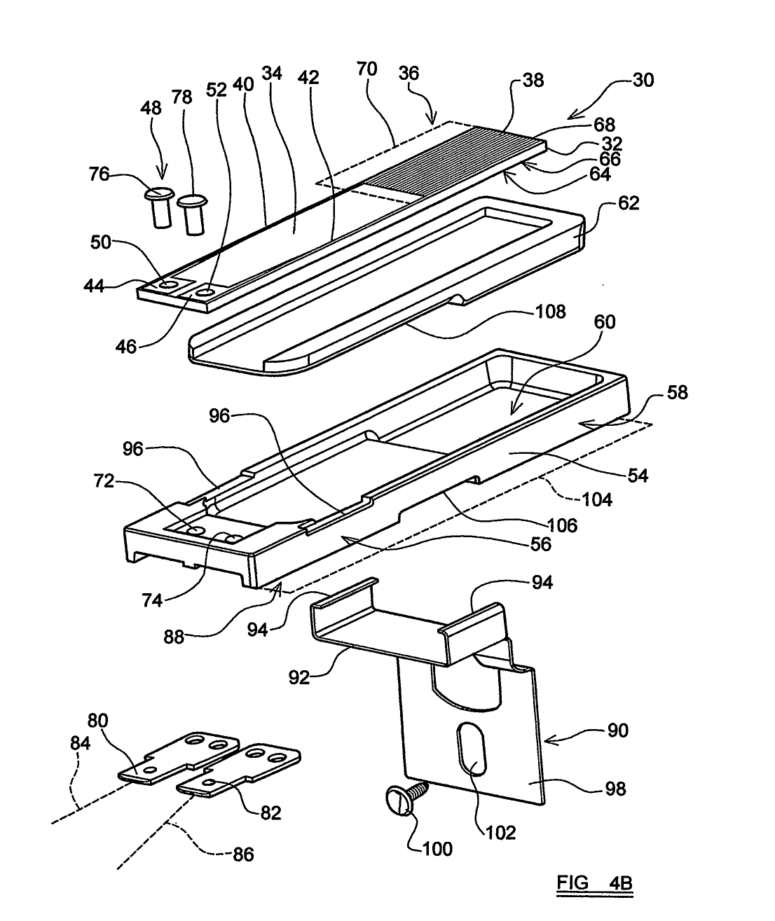

FIG. 4A is a perspective view of another embodiment of temperature sensor assembly of the present invention for use in the arrangement of FIGS. 1 and 2;

FIG. 4B is an exploded view of the temperature sensor assembly of FIG. 4A;

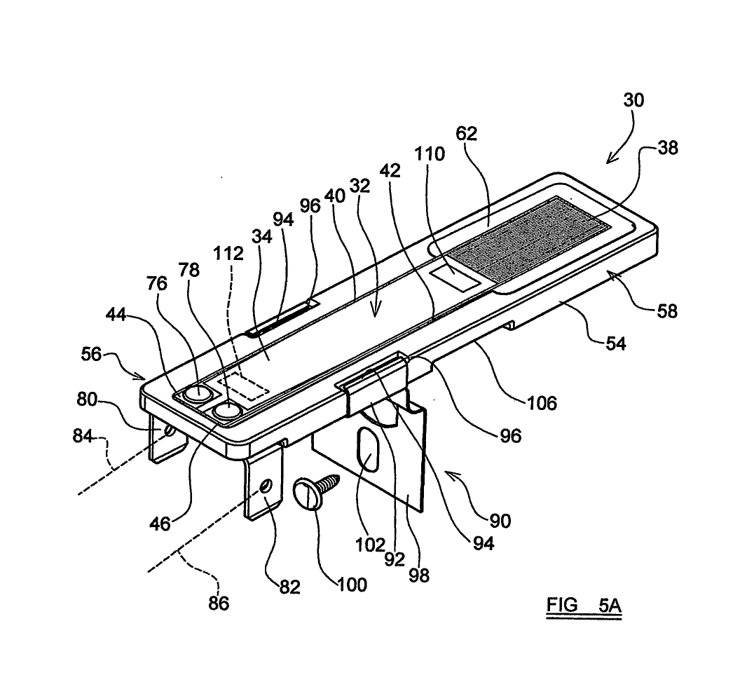

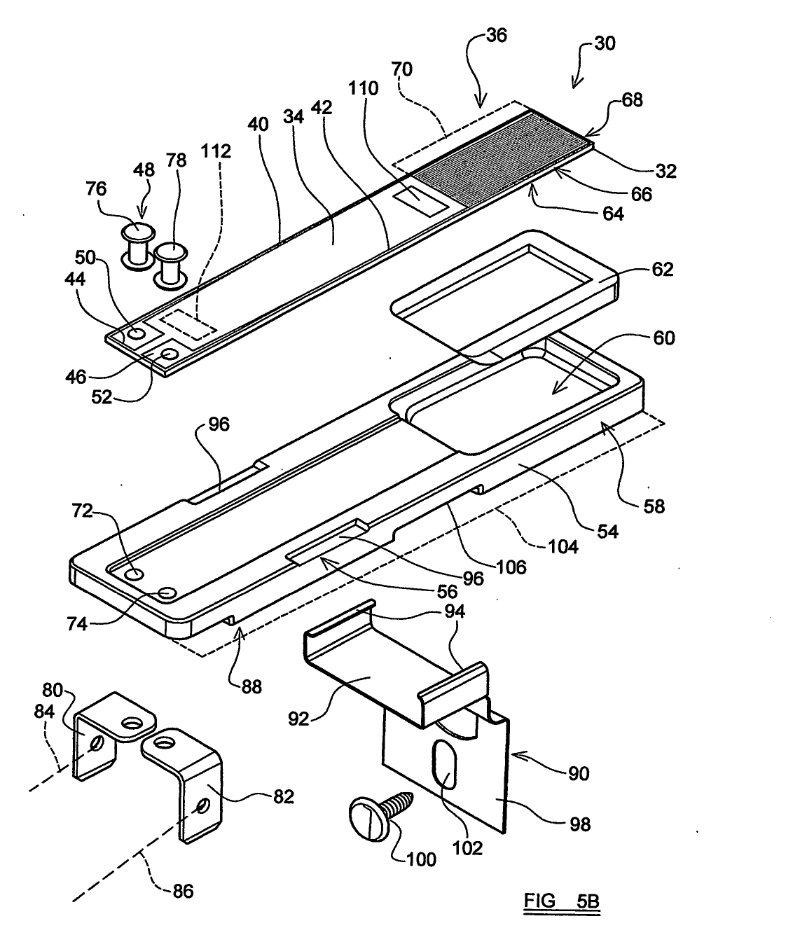

FIG. 5A is a perspective view of a further embodiment of temperature sensor assembly of the present invention for use in the arrangement of FIGS. 1 and 2;

FIG. 5B is an exploded view of the temperature sensor assembly of FIG. 5A;

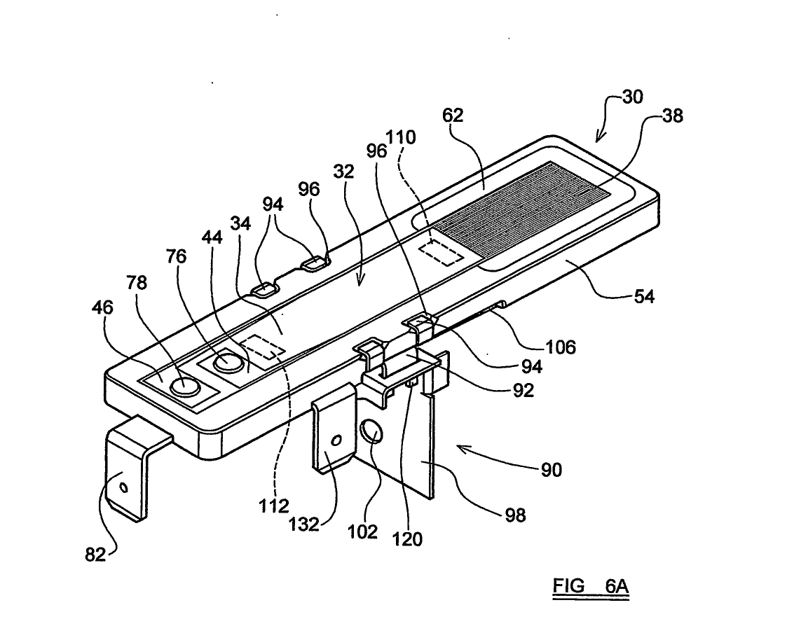

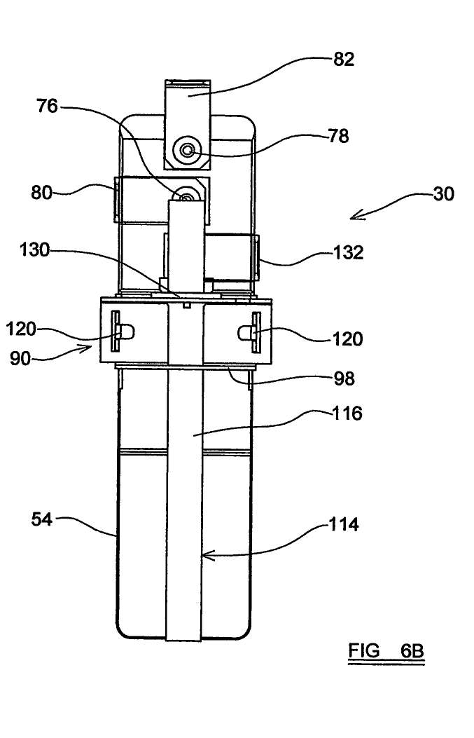

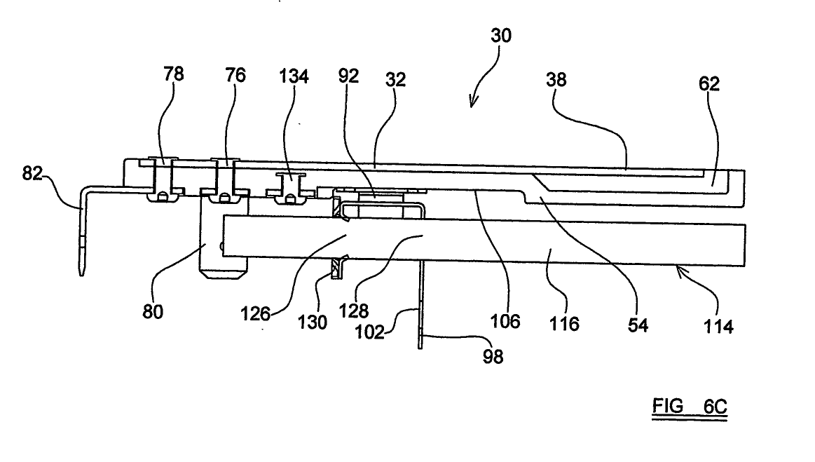

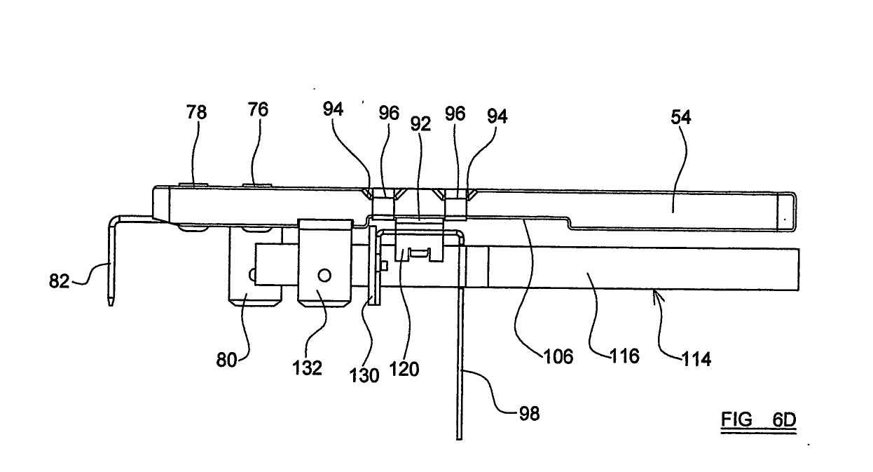

FIG. 6A is a perspective view of a still further embodiment of temperature sensor assembly of the present invention for use in the arrangement of FIGS. 1 and 2;

FIG. 6B is a view from below of the temperature sensor assembly of FIG. 6A;

FIG. 6C is a cross-sectional view of the temperature sensor assembly of FIG. 6A;

FIG. 6D is a side view of the temperature sensor assembly of FIG. 6A;

FIG. 6E is an exploded view of the temperature sensor assembly of FIG. 6A; and

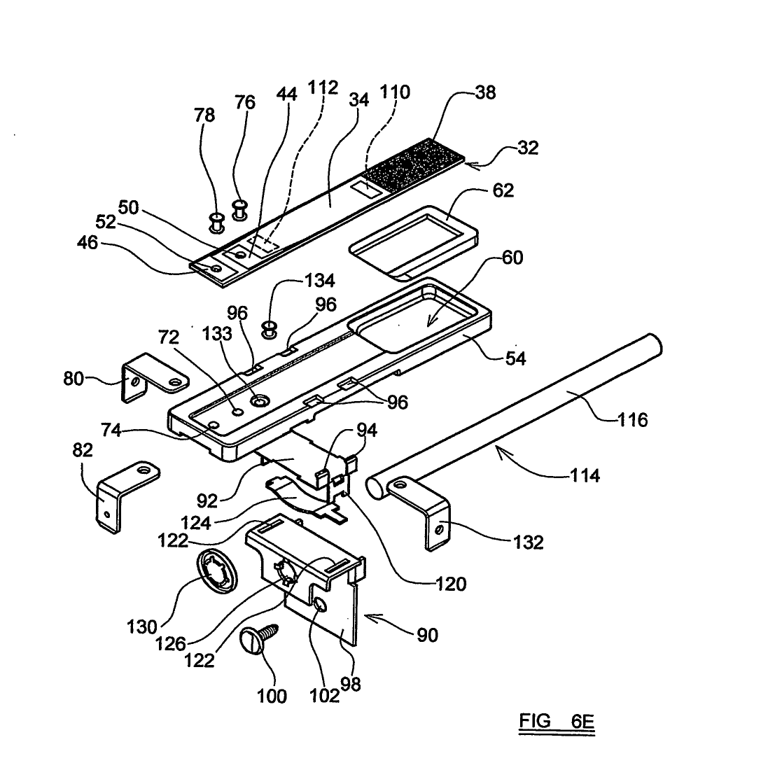

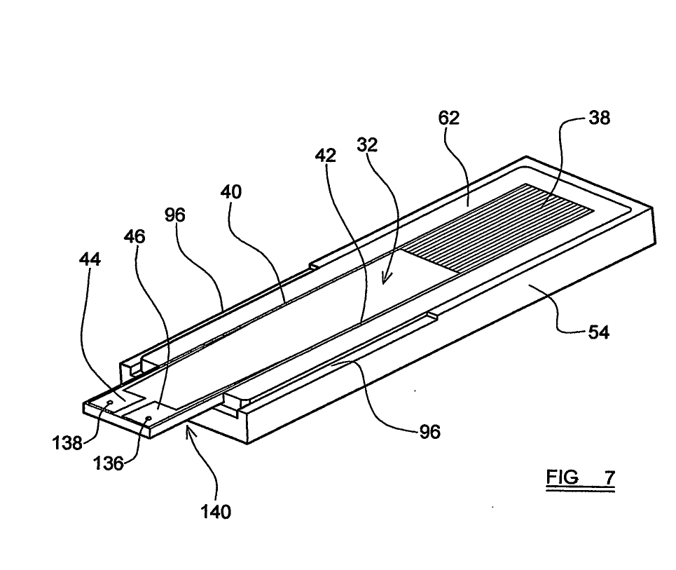

FIG. 7 is a perspective view of yet another embodiment of temperature sensor assembly of the present invention for use in the arrangement of FIGS. 1 and 2.

Referring to FIGS. 1 and 2, an electrical heating arrangement 2 comprises a glass-ceramic cooking plate 4 of well-known form, having an upper surface 6 for receiving a cooking utensil 8, such as a pan. A lower surface 10 of the cooking plate 4 has an electric heater 12 supported in contact therewith. The electric heater 12 comprises a dish-like support 14, such as of metal, in which is provided a base layer 16 of thermal and electrical insulation material, such as microporous thermal and electrical insulation material. A peripheral wall 18 of thermal insulation material is arranged to contact the lower surface 10 of the cooking plate 4.

At least one radiant electrical resistance heating element 20 is supported relative to the base layer 16. The heating element or elements can comprise any of the well-known forms of heating element, such as wire, ribbon, foil or lamp forms, or combinations thereof. In particular, the heating element or elements 20 can be of corrugated ribbon form, supported edgewise on the base layer 16 of insulation material.

It is to be understood, however, that the present invention is not limited to a heater incorporating at least one radiant electrical resistance heating element 20. Instead of the radiant electrical resistance heating element or elements, at least one electrical induction heating element could be provided.

A terminal block 22 is provided at an edge region of the heater 12, for connecting the heating element or elements 20 to a power supply 24 by way of leads 26 and through a control means 28, which may be a microprocessor-based control arrangement.

The cooking utensil 8 is heated by the heating element or elements 20 and its temperature is monitored by a temperature sensor assembly 30, which will be described in detail hereinafter, and which is located in contact with the lower surface 10 of the cooking plate 4. In particular, the temperature sensor assembly 30 is adapted to measure small increases in temperature of the cooking utensil 8 through the cooking plate 4 resulting, for example, from a boil-dry event occurring in the cooking utensil 8.

Referring to FIGS. 3A and 3B, the temperature sensor assembly 30 comprises a substantially planar thin elongate substrate 32, such as of ceramic or other electrically insulating material, having an upper surface 34 and provided at a first end region 36 thereof with a temperature-sensitive electrical resistance element 38 of film form and suitably comprising platinum. The resistance element 38 may be deposited onto the surface 34 of the substrate 32 by a thick film printing technique, although other deposition techniques may be applied. The ceramic substrate 32 suitably has a thickness of between about 0.5 and 1 mm and suitably comprises alumina. A suitable electrical resistance value for the temperature-sensitive electrical resistance element is between about 50 and about 1000 ohms at 0 degrees Celsius, and preferably between about 100 and about 500 ohms.

Electrical connecting leads 40, 42, also of film form, are provided on the upper surface 34 of the substrate 32 and are electrically connected to the temperature-sensitive electrical resistance element 38. The electrical connecting leads 40, 42 suitably comprise the same or similar material as the electrical resistance element 38 and extend to terminal pads 44, 46 provided at a second end region 48 of the substrate 32. The terminal pads 44, 46 may comprise substantially the same or similar material as the electrical connecting leads 40, 42 or may comprise a different material, such as gold. Holes 50, 52 are provided through the pads 44, 46 and through the substrate 32.

An elongate support member 54, arranged as a beam, is adapted to extend at least partly across the heater 12 from a peripheral region of the heater, across an aperture or recess in the peripheral wall 18 and a rim of the dish-like support 14, with a first end 56 of the support member 54 secured externally of the heater at the peripheral region of the heater and with a second end 58 thereof located within the heater. The support member 54 suitably comprises a ceramic material, such as steatite, cordierite or alumina, and is provided with an elongate recess 60 into which is received the substrate 32. The temperature-sensitive electrical resistance element 38 is located at or near the second end 58 of the support member 54 within the heater 12 and the terminal pads 44, 46 are located externally of the heater, at the first end 56 of the support member, where they are subjected to a relatively low temperature.

Thermal insulation means 62 is provided in the recess 60 in the support member 54, interposed between the support member 54 and a lower surface 64 and side edges 66, 68 of the substrate 32. The thermal insulation means 62 preferably comprises a thin layer of microporous thermal insulation material, suitably of a thickness between 1 and 4 mm and preferably between 2 and 3 mm.

Alternatively or additionally, the thermal insulation means 62 could comprise granular thermal insulation material, such as vermiculite or calcium silicate.

The substrate 32 and thermal insulation means 62 may be press-moulded into the recess 60 in the support member 54, such that the upper surface 34 of the substrate 32 is substantially planar with that of the support member 54.

An electrically insulating or passivation layer 70 may be provided on the upper surface 34 of the ceramic substrate 32, at least overlying the temperature-sensitive electrical resistance element 38. The passivation layer may also provide improved abrasion resistance.

Holes 72, 74 are provided through the support member 54 at the first end 56 thereof. The holes 72, 74 are aligned with the holes 50, 52 in the ceramic substrate 32 and are arranged to receive electrically connecting members 76, 78, suitably comprising bolts, pins or rivets, for electrically connecting the terminal pads 44, 46 to terminal tabs or pins 80, 82 and for mechanically securing the ceramic substrate 32 to the support member 54. The terminal tabs or pins 80, 82 are arranged for electrically connecting the temperature-sensitive electrical resistance element 38 to the control arrangement 28 by means of leads 84, 86. When the electrically connecting members 76, 78 comprise bolts, such bolts suitably comprise brass, plated with silver or nickel. When the electrically connecting members 76, 78 comprise rivets, such rivets suitably comprise copper, plated with gold.

The terminal tabs or pins 80, 82 are arranged to extend laterally at the first end 56 of the support member 54 and from a lower surface 88 of the support member 54, whereby adequate clearance is provided between the terminal tabs or pins 80, 82 and the lower surface of the cooking plate 4.

A metal mounting bracket 90 is provided for the temperature sensor assembly. The mounting bracket 90 suitably comprises stainless steel and has a first portion 92 arranged with clip means 94 securely engaging portions 96 of the first end 56 of the support member 54. The engaging portions 96 are suitably provided as recesses or rebates in the support member 54. The mounting bracket 90 has a second portion 98 secured to the rim of the dish-like support 14 of the heater 12 by means of a threaded fastener 100 passing through a hole 102 in the second portion 98 of the mounting bracket 90. The mounting bracket 90 is provided of cantilevered form from a single bent sheet or strip of metal and such that the second end 58 of the support member 54 is spring-biased towards the lower surface 10 of the cooking plate 4. In this way, the upper surface of the temperature sensor assembly 30 is maintained substantially in contact with the lower surface 10 of the cooking plate 4.

The external lower surface 88 of the support member 54 may be provided with a layer 104 of thermal radiation-reflecting material to reflect incident thermal radiation from the heating element or elements 20.

The resulting temperature sensor assembly 30 is compact and sensitive and with the thermal insulation means well protected therein. In the heating arrangement 2, it is able to monitor small increases in temperature in the cooking plate 4 and the cooking utensil 8, resulting for example from a boil-dry event in the cooking utensil 8, without problems of interference from thermal “noise” resulting from fluctuations of a set-point temperature selected for operation of the heater 12. The temperature sensor assembly 30 is therefore able to operate rapidly and efficiently, in cooperation with the control means 28, to de-energise the heating element or elements 20 when a problem such as a boil-dry event occurs.

FIGS. 4A and 4B illustrate another embodiment of the temperature sensor assembly 30, which is substantially the same as the temperature sensor assembly 30 of FIGS. 3A and 3B, with the following exceptions. Firstly, the elongate support member 54 is provided with a transverse recess 106 extending across the lower surface 88 thereof in a location where the support member 54 traverses the aperture or recess in the peripheral wall 18 of the heater 12. The size of the aperture or recess in the peripheral wall 18 is thereby able to be minimised, thus ensuring that the maximum possible depth of the peripheral wall 18 is maintained. With this arrangement, it is necessary for the thermal insulation means 62 to be provided of reduced thickness in a region 108 thereof overlying the transverse recess 106. Secondly, the terminal tabs or pins 80, 82 are arranged to extend longitudinally, rather than laterally at the first end 56 of the support member 54. This arrangement of the terminal pads or pins could, of course, be provided as an alternative in the embodiment of FIGS. 3A and 3B.

FIGS. 5A and 5B illustrate a further embodiment of the temperature sensor assembly 30 which is a modification of the embodiment of FIGS. 4A and 4B. Here the thermal insulation means 62 is provided substantially only at the region where the temperature-sensitive electrical resistance element 38 is arranged. In order to maintain efficiency of operation of the assembly, such that thermal conduction effects along the ceramic substrate 32 are minimised or reduced, a slot 110 is provided extending through and partly across the ceramic substrate 32 in the vicinity of a region where the electrical connecting leads 40, 42 extend from the temperature-sensitive electrical resistance element 38. A further slot 112 may be provided near the terminal pads 44, 46.

A further arrangement of the terminal tabs or pins 80, 82 is shown in FIGS. 5A and 5B. Here the terminal tabs or pins 80, 82 extend downwardly at the first end 56 of the support member 54. This further arrangement is also applicable to the embodiments of FIGS. 3A and 4A.

FIGS. 6A to 6E illustrate another embodiment of the temperature sensor assembly 30, which is similar to that shown in FIGS. 5A and 5B with the main exceptions that a different form of spring-biased mounting bracket 90 is provided, the mounting bracket being also adapted to support an additional temperature-responsive device 114 having a rod-like or beam-like sensing portion 116 adapted to extend beneath the elongate support beam 54 at least partly across the heater 12 from a peripheral region of the heater and adapted to monitor temperature in a cavity 118 of the heater formed between the heating element or elements 20 and the lower surface 10 of the cooking plate 4. Such temperature-responsive device 114 may be arranged to be electrically connected to and to cooperate with the control means 28, by way of connecting leads 119 (FIG. 1), for de-energising the heating element or elements 20 at a predetermined (variable) temperature and/or for controlling the temperature in the cavity 118 at a selected set point within predetermined limits. The temperature-responsive device 114 may be an electro-mechanical device of known form or an electronic probe incorporating a temperature-sensitive electrical resistance element.

Referring to FIGS. 6A to 6E in more detail, the metal mounting bracket 90, suitably of stainless steel, has a first portion 92 forming an upper component and secured to the elongate support member 54 by means of clips 94 which engage portions 96 of the support member provided as recesses or rebates in the support member 54. The mounting bracket 90 has a second portion 98 forming a lower component and arranged for securing to the rim of the dish-like support 14 of the heater 12 by means of a threaded fastener 100 passing through a hole 102 in the second portion 98 of the mounting bracket. The first and second portions 92, 98 are assembled together by a retaining tab 120 and slot 122 arrangement, such that limited relative displacement in a substantially vertical plane (i.e., perpendicular to the plane of the slot) is permitted therebetween. A leaf spring arrangement 124 (which could be substituted by a coil spring arrangement) is provided intermediate the relatively-displaceable first and second portions 92, 98 and acts to urge the elongate support member 54 towards the lower surface 10 of the cooking plate 4. The second portion 98 is provided with aligned apertures 126, 128 therethrough for receiving the rod-like or beam-like portion 116 of the temperature-responsive device 114, which is retained therein by clip means 130.

In addition to the terminal tabs or pins 80, 82 provided for electrical connection of the temperature-sensitive electrical resistance element 38, as in FIGS. 3 to 5, a third terminal tab or pin 132 may be provided secured to the support member 54, through a hole 133, by means such as a rivet 134 and can be used to simplify connection of the temperature-responsive device 114 and the temperature-sensitive electrical resistance element 38 to the control means 28.

Referring again to FIGS. 3A and 3B, instead of providing holes 50, 52 through the terminal pads 44, 46 and substrate 32, and holes 72, 74 through the support member 54, for receiving the electrically connecting members 76, 78 connected to the tabs or pins 80, 82, the pads 44, 46 could simply be arranged as shown in FIG. 7 with external lead wires 136, 138 connected thereto by means of high temperature solder or by brazing or welding. Such connections may be facilitated by arranging for end region 140 of the ceramic substrate 32 to extend beyond the end of the support member 54.

Furthermore, by providing the recesses or rebates 96 of extended length in the support member 54, as shown in FIG. 7, the mounting bracket 90 of FIGS. 3 to 6 may be applied and its position adjusted, as required, along a predetermined length of the support member 54.

The temperature sensor assembly can be used in heaters having more than one heating zone, the heating zones for example being separated by a dividing wall. In such a case, more than one temperature-sensitive electrical resistance element can be provided on the substrate and the assembly will be constructed such that the multiple temperature-sensitive elements fall in use into different heating zones.

1. A temperature sensor assembly for an electrical heating arrangement (2), the temperature sensor assembly comprising: a thin substantially planar substrate (32) having a first, exposed surface (34) provided with a temperature-sensitive electrical resistance element (38) of film form, and a second surface (64), the temperature-sensitive electrical resistance element being provided with electrical connecting leads (40, 42); a support member (54) having a first surface adapted to receive the substantially planar substrate (32) with the second surface (64) of the substrate juxtaposed therewith; and thermal insulation means (62) interposed between at least the second surface (64) of the substantially planar substrate and the support member at least at a region where the temperature-sensitive electrical resistance element (38) is provided.

2. An assembly as claimed in claim 1, wherein the support member (54) has a recess (60) provided in its first surface, the recess being adapted and arranged to receive the substantially planar substrate (32) and the thermal insulation means (62).

3. An assembly as claimed in claim 2, wherein the thermal insulation means (62) is additionally interposed between the support member (54) and at least one side edge (66, 68) of the substantially planar substrate (32) in the recess (60).

4. An assembly as claimed in claim 1, wherein the thermal insulation means (62) comprises a thin layer of thermal insulation material selected from microporous thermal insulation material, vermiculite, perlite, mineral fibres, calcium silicate, inorganic foam, and mixtures thereof.

5. (canceled)

6. An assembly as claimed in claim 1, wherein the thermal insulation means (62) is provided with a thickness thereof of from 1 to 10 mm, between the substantially planar substrate (32) and the support member (54).

7. An assembly as claimed in claim 6, wherein the thermal insulation means (62) is provided with a thickness of from 2 to 4 mm.

8. An assembly as claimed in claim 1, wherein the support member (54) comprises a ceramic material.

9. An assembly as claimed in claim 8, wherein the ceramic material is selected from steatite, cordierite and alumina.

10. An assembly as claimed in claim 1, wherein the support member (54) comprises a metal.

11. An assembly as claimed in claim 10, wherein the metal is stainless steel.

12. An assembly as claimed in claim 1, wherein the substantially planar substrate (32) is selected from a ceramic material and a metallic material having a dielectric coating.

13. An assembly as claimed in claim 12, wherein the ceramic material is selected from a ceramic comprising 85-99 weight percent alumina, glass ceramic and aluminium nitride.

14. An assembly as claimed in claim 1, wherein the substantially planar substrate (32) has a thickness from about 0.25 mm to about 3 mm.

15. An assembly as claimed in claim 14, wherein the substantially planar substrate (32) has a thickness from about 0.5 mm to about 1 mm.

16. An assembly as claimed in claim 1, wherein the support member (54) is of elongate form arranged as a beam and adapted to extend at least partly across a heater (12) of an electrical heating arrangement, the beam being adapted to extend from a peripheral region of the heater.

17. An assembly as claimed in claim 16, wherein the support member (54) of elongate form has a first end (56) thereof adapted to be secured at the peripheral region of the heater (12) and a second end (58) thereof adapted to be within the heater, the temperature-sensitive electrical resistance element (38) being located in a position selected from at the second end thereof and near the second end thereof, with the electrical connecting leads (40, 42) extending from the temperature-sensitive electrical resistance element to the first end of the support member.

18. An assembly as claimed in claim 16, wherein the substantially planar substrate (32) is of elongate form, extending along the elongate support member (54) and having the temperature-sensitive electrical resistance element (38) located at a first end region (36) thereof and with the electrical connecting leads (40, 42) being provided of film form on the substrate and extending to a second end region (48) thereof located at the first end (56) of the support member.

19. An assembly as claimed in claim 18, wherein the film-form electrical connecting leads (40, 42) comprise substantially the same material as the temperature-sensitive electrical resistance element (38).

20. An assembly as claimed in claim 18, wherein electric terminal means (44, 46) for the film-form electrical connecting leads (40, 42) are provided at the second end region (48) of the substantially planar substrate (32).

21. An assembly as claimed in claim 20, wherein the electric terminal means (44, 46) comprise electrically conductive pads.

22. An assembly as claimed in claim 21, wherein the electrically conductive pads (44, 46) comprise material selected from substantially the same material as the electrical connecting leads (40, 42) and gold.

23. (canceled)

24. An assembly as claimed in claim 20, wherein external connecting leads (136, 138) are arranged to be connected to the electric terminal means (44, 46).

25. An assembly as claimed in claim 24, wherein the external connecting leads (136, 138) are arranged to be connected to the electric terminal means (44, 46) by methods selected from soldering, brazing and welding.

26. An assembly as claimed in claim 21 wherein holes (50, 52) are provided through the pads (44, 46) and through the substantially planar substrate (32), for receiving electrically connecting members (76, 78).

27. An assembly as claimed in claim 26, wherein the electrically connecting members (76, 78) have electrically conductive terminal means selected from tabs and pins (44, 46) associated therewith for connection to external circuitry (84, 86).

28. An assembly as claimed in claim 26, wherein the holes (72, 74) are also provided through an underlying region of the support member (54) and arranged to receive the electrically connecting members (38), whereby the substantially planar substrate (32) is secured to the support member.

29. An assembly as claimed in claim 26, wherein the electrically connecting members (76, 78) comprise means selected from bolts, pins and rivets.

30. An assembly as claimed in claim 29, wherein the bolts (76, 78) comprise brass, plated with material selected from gold, silver and nickel.

31. An assembly as claimed in claim 29, wherein the rivets (76, 78) comprise material selected from brass and copper, plated with material selected from gold, silver and nickel.

32. An assembly as claimed in claim 18, wherein the thermal insulation means (62) is provided interposed between the elongate substantially planar substrate (32) and the elongate support member (54) over a region selected from substantially the full length of the substrate and substantially only a region of the substrate where the temperature-sensitive electrical resistance element (38) is provided.

33. An assembly as claimed in claim 32, wherein the thermal insulation means (62) is provided substantially only at the region where the temperature-sensitive electrical resistance element (38) is provided.

34. An assembly as claimed in claim 32, wherein at least one slot means (110, 112) is provided extending through and partly across the substrate (32), whereby thermal conduction along the substrate is reduced.

35. An assembly as claimed in claim 1, wherein a metal mounting bracket (90) is provided, having a first portion (92) thereof secured to the first end (56) of the elongate support member (54), adapted to be secured externally of a heater (12) of an electrical heating arrangement, and a second portion (98) thereof for securing to an external region of the heater.

36. An assembly as claimed in claim 35, wherein the second portion (98) of the bracket (90) is adapted to be secured to an external region at a peripheral wall (18) of the heater (12).

37. An assembly as claimed in claim 35, wherein the first portion (92) of the mounting bracket (90) is arranged with clip means (94) engaging portions of the first end (56) of the elongate support member (54).

38. An assembly as claimed in claim 37, wherein the engaged portions of the first end (56) of the elongate support member (54) are provided in forms selected from recesses and rebates in the elongate support member.

39. An assembly as claimed in claim 38, wherein the recesses and rebates are dimensioned to allow longitudinal adjustment of the elongate support member (54) on the first portion (92) of the mounting bracket (90).

40. An assembly as claimed in claim 35, wherein the mounting bracket (90) is adapted and arranged to bias the elongate support member (54) towards the lower surface (10) of a cooking plate (4) of an electrical heating arrangement.

41. An assembly as claimed in claim 40, wherein the mounting bracket (90) is of cantilevered form, formed from a form selected from a single sheet and a strip of metal and arranged, such that, when fitted to the heater (12), the second end (58) of the elongate support member (54) is biased upwardly towards the lower surface (10) of the cooking plate (4).

42. An assembly as claimed in claim 41, wherein the mounting bracket (90) has the first and second portions (92, 98) formed separately, to provide upper and lower components respectively, and assembled together such that limited relative displacement in a substantially vertical plane is permitted therebetween, spring means (124) being provided intermediate the relatively-displaceable first and second portions and acting to urge the elongate support member (54) towards the lower surface (10) of the cooking plate (4).

43. An assembly as claimed in claim 42, wherein the spring means (124) is of a form selected from coil spring form and leaf spring form.

44. An assembly as claimed in claim 35, wherein the mounting bracket (90) comprises material selected from stainless steel, plated mild steel and a high temperature resistant plastics material.

45. An assembly as claimed in claim 1, wherein a temperature-responsive means (114) is additionally provided having a portion selected from a rod-like portion and a beam-like portion.

46. An assembly as claimed in claim 45, wherein the support member (54) is of elongate form arranged as a beam and adapted to extend at least partly across a heater (12) of an electrical heating arrangement, the beam being adapted to extend from a peripheral region of the heater and the temperature-responsive means (114) is arranged with the rod-like portion and beam-like portion at a location substantially underlying the elongate support member (54) of the temperature sensor assembly.

47. An assembly as claimed in claim 46, wherein a metal mounting bracket (90) is provided, having a first portion (92) thereof secured to the first end (56) of the elongate support member (54), adapted to be secured externally of a heater (12) of an electrical heating arrangement, and a second portion (98) thereof for securing to an external region of the heater, and the temperature-responsive means (114) shares the mounting bracket (90) provided for the elongate support member (54) of the temperature sensor assembly.

48. An assembly as claimed in claim 1, wherein the support member (54) has a second surface (88) thereof provided with a layer (104) of thermal radiation-reflecting material.

49. (canceled)

50. An assembly as claimed in claim 1, wherein the temperature-sensitive electrical resistance element (38) comprises platinum.

51. An electrical heating arrangement comprising: a cooking plate (4) having an upper surface (6) for receiving a cooking utensil (8), and a lower surface (10); an electric heater (12) incorporating at least one electric heating element (20), the heater being supported in contact with the lower surface of the cooking plate; and a temperature sensor assembly (30) as claimed in claim 1, the temperature sensor assembly being located in the electrical heating arrangement (2) spaced above the at least one electric heating element in contact with the lower surface of the cooking plate and with the temperature-sensitive electrical resistance element (38) facing the lower surface of the cooking plate.

52. An arrangement as claimed in claim 51, wherein the cooking plate (4) comprises glass-ceramic material.

53. An arrangement as claimed in claim 51, wherein the elongate support member (54) traverses an opening portion selected from an aperture and a recess provided in a peripheral wall (18) of the electric heater (12) and such that the first end (56) of the elongate support member (54) is located externally of the heater.

54. An arrangement as claimed in claim 53, wherein the elongate support member (54) is provided with a transverse recess extending across a lower surface thereof in a location where the elongate support member traverses the opening portion in the peripheral wall (18) of the heater, whereby the size of the opening portion in the peripheral wall is able to be minimised.

55. An arrangement as claimed in claim 53, wherein the peripheral wall (18) comprises thermal insulation material.

56. An arrangement as claimed in claim 53, wherein the substantially planar substrate (32) also traverses, on the elongate support member (54), the opening portion provided in the peripheral wall (18) of the electric heater (12), such that the second end region (48) of the substrate is located externally of the heater.

57. An arrangement as claimed in claim 51, wherein the at least one electric heating element (20) comprises an element selected from a radiant electrical resistance heating element and an electrical induction heating element.
